(19) United States
(12) Patent Application Publication
(10) Pub. No.: US 2025/0065580 A1
(43) Pub. Date: Feb. 27, 2025

(54) REPAIR DEVICE, REPAIR SYSTEM, AND REPAIR METHOD

(71) Applicant: MITSUBISHI HEAVY INDUSTRIES, LTD., Tokyo (JP)

(72) Inventor: Tomohiro MURAI, Tokyo (JP)

(21) Appl. No.: 18/783,427

(22) Filed: Jul. 25, 2024

(30) Foreign Application Priority Data
Aug. 23, 2023 (JP) 2023-135636

(51) Int. Cl. B29C 73/02; B29C 73/24; B64F 5/40

(52) U.S. Cl. CPC B29C 73/02; B29C 73/24; B64F 5/40

(57) ABSTRACT

A repair device includes a casing having a box shape, being open in a first direction, and extending in a second direction intersecting the first direction, a brush device housed in the casing from the first direction, and a jack unit positioned between a bottom surface of the casing and the brush device and configured to adjust a position of the brush device in the first direction relative to the bottom surface of the casing, in which the brush device includes a base, a guide positioned at a fixed position relative to the base and protruding from an opening in the casing in the first direction, multiple brushes attached to the base, protruding from the opening in the casing in the first direction beyond the guide, and configured to apply sealant to a surface to be treated facing the first direction, and an actuator configured to adjust positions of the multiple brushes in a third direction intersecting the first direction and the second direction by moving the base in the third direction.

### CROSS-REFERENCE TO RELATED APPLICATIONS

This application claims the benefit of priority to Japanese Patent Application Number 2023-135636 filed on Aug. 23, 2023. The entire contents of the above-identified application are hereby incorporated by reference.

### TECHNICAL FIELD

The present disclosure relates to a repair device, a repair system, and a repair method.

### RELATED ART

JP 2020-104443 A discloses a structure of an aircraft wing. The wing includes an outer panel and a stringer. The outer panel and the stringer are stacked on top of each other. The stringer includes a connection part connected with the outer panel and a projection that is spaced apart from the outer panel. A hollow space is formed between the projection and the outer panel.

JP 6071359 B discloses a method of manually applying sealant to a defect using a brush to repair the defect.

### SUMMARY

A defect may occur in the hollow space between the outer panel and the stringer. In such a case, since the defect occurs in a very narrow space, it is difficult to repair the defect by manually applying sealant using a brush as described above.

The present disclosure has been made to solve the above problem, and an object of the present disclosure is to provide a repair device, a repair system, and a repair method that can easily perform a repair process using sealant.

To solve the above problem, a repair device according to the present disclosure includes a casing having a box shape, being open in a first direction, and extending in a second direction intersecting the first direction, a brush device housed in the casing from the first direction, and a jack unit positioned between a bottom surface of the casing and the brush device and configured to adjust a position of the brush device in the first direction relative to the bottom surface of the casing, in which the brush device includes a base, a guide positioned at a fixed position relative to the base and protruding from an opening in the casing in the first direction, multiple brushes attached to the base, protruding from the opening in the casing in the first direction beyond the guide, and configured to apply sealant to a surface to be treated facing the first direction, and an actuator configured to adjust positions of the multiple brushes in a third direction intersecting the first direction and the second direction by moving the base in the third direction.

A repair system according to the present disclosure includes the repair device described above, a pipe coupled to the repair device from the second direction, and a movement mechanism configured to grip an end portion of the pipe on a side far from the repair device in the second direction and move the pipe in the second direction.

A repair method according to the present disclosure is a repair method using the repair device described above, in which the jack unit is a bag configured to adjust a position of the base in the first direction by expanding or contracting using internal air pressure, the repair method includes pressing the multiple brushes against the surface to be treated facing the first direction in the first direction by supplying air into the bag, moving the repair device in the second direction with the multiple brushes pressed against the surface to be treated, and separating the multiple brushes from the surface to be treated in the first direction by exhausting the air in the bag while moving the repair device in the second direction.

According to the repair device, the repair system, and the repair method of the present disclosure, it is possible to easily perform the repair process using sealant.

### BRIEF DESCRIPTION OF DRAWINGS

The disclosure will be described with reference to the accompanying drawings, wherein like numbers reference like elements.

FIG. 1 is a side view illustrating a schematic configuration of a repair system according to an embodiment of the present disclosure.

FIG. 2 is a plan view illustrating a schematic configuration of an automation device according to the embodiment of the present disclosure.

FIG. 3 is a perspective view illustrating a portion of a target object according to the embodiment of the present disclosure.

FIG. 4 is a cross-sectional view illustrating a schematic configuration of a coupling member according to the embodiment of the present disclosure.

FIG. 5 is a plan view illustrating a schematic configuration of a repair device according to the embodiment of the present disclosure.

FIG. 6 is an exploded perspective view illustrating a schematic configuration of the repair device according to the embodiment of the present disclosure.

FIG. 7 is a front view illustrating a schematic configuration of the repair device according to the embodiment of the present disclosure.

FIG. 8 is a schematic diagram illustrating how to use the repair device according to the embodiment of the present disclosure.

FIG. 9 is a flowchart illustrating a procedure of a repair method according to the embodiment of the present disclosure.

### DESCRIPTION OF EMBODIMENTS

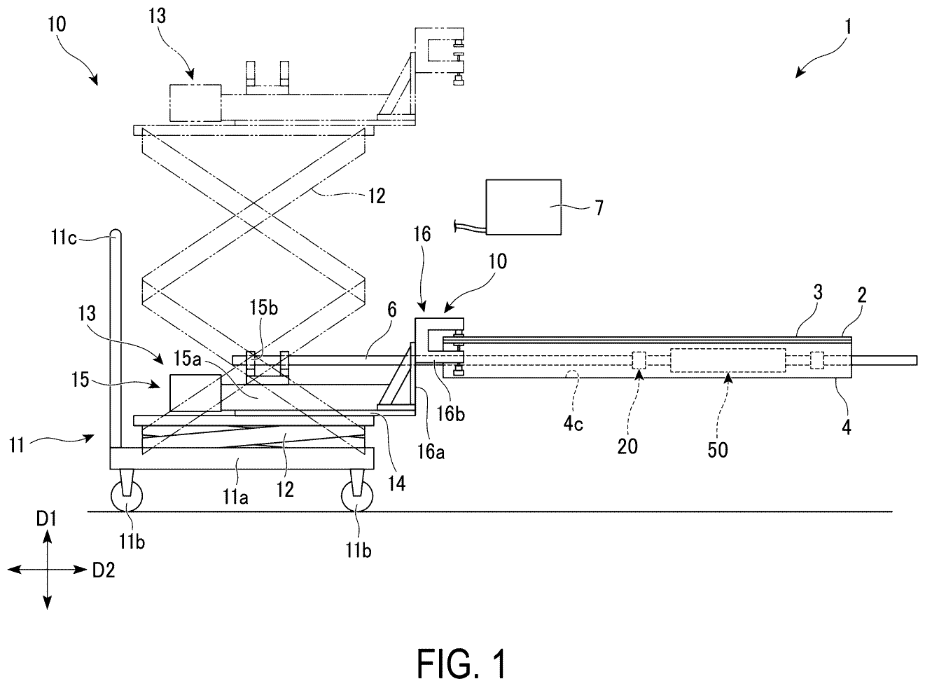

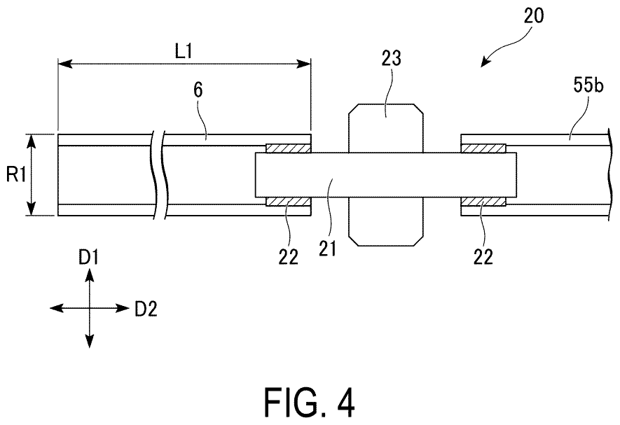

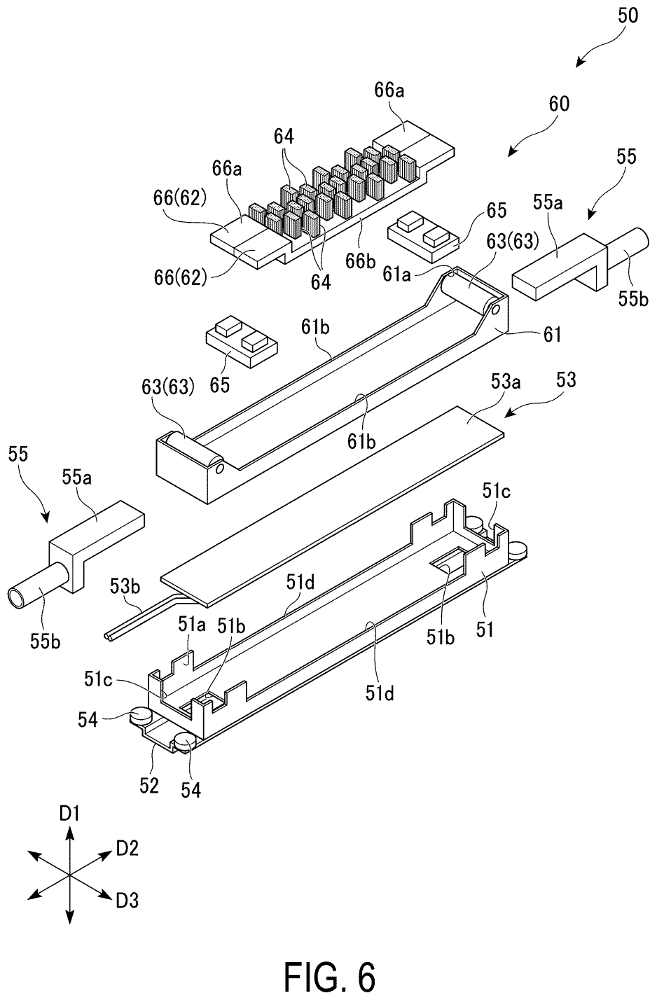

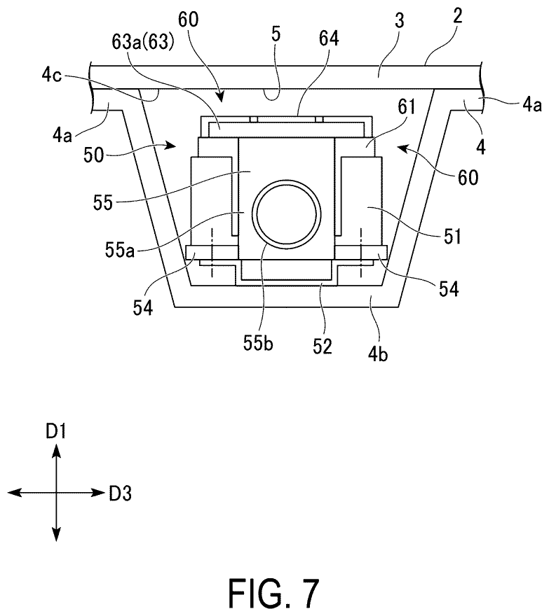

A repair device 50, a repair system 1, and a repair method according to an embodiment of the present disclosure will be described below with reference to FIGS. 1 to 9.

### Repair System

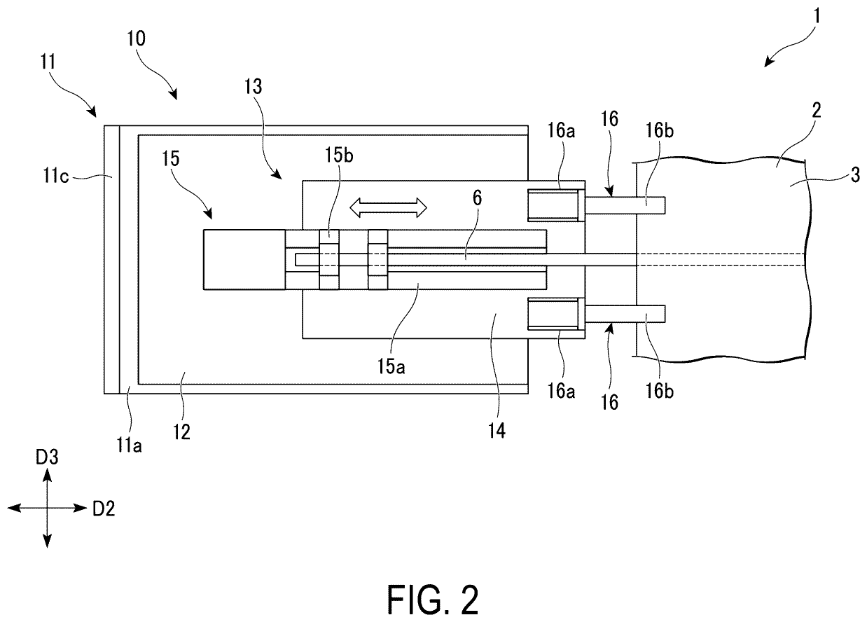

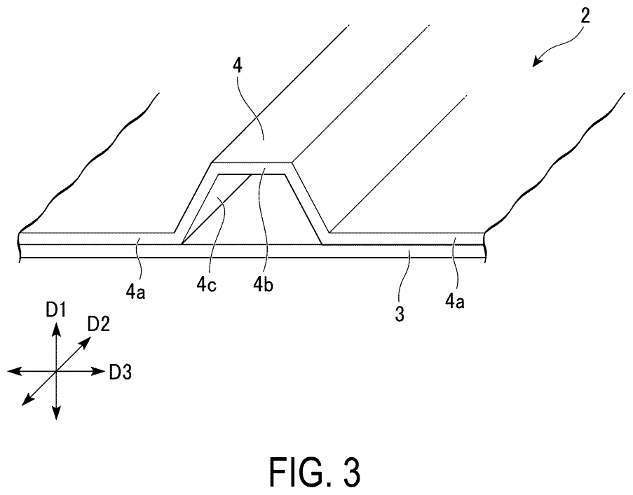

The repair system 1 (see FIGS. 1 and 2) is used, for example, to repair an aircraft wing. Hereinafter, the wing to be repaired is referred to as a target object 2. As illustrated in FIG. 3, the target object 2 includes an outer panel 3 and a stringer 4.

The outer panel 3 forms an outer shell of the aircraft wing. The outer panel 3 is formed in a flat plate shape, for example. The stringer 4 is attached to the outer panel 3. The stringer 4 includes a connection part 4a that connects to the outer panel 3 and a projection 4b that separates from the outer panel 3. The connection part 4a is located closer to the outer panel 3 than the projection 4b. The projection 4b is located farther from the outer panel 3 than the connection part 4a.

A hollow space (hereinafter referred to as a narrow space 4c) is formed between the projection 4b and the outer panel 3. The stringer 4 is, for example, a hat-shaped hat stringer. The outer panel 3 and the stringer 4 are made of a composite material such as glass fiber reinforced plastics (GFRP) or carbon fiber reinforced plastics (CFRP).

The repair system 1 illustrated in FIGS. 1 and 2 is used for repair work in the narrow space 4c between the projection 4b and the outer panel 3. The repair system 1 performs brush coating by applying sealant to a defect occurred on a surface of the outer panel 3 (hereinafter referred to as a surface to be treated 5) in the narrow space 4c with brushes 64 described later (repair process using sealant).

The repair system 1 includes the repair device 50, an automation device 10, a pipe 6, and a coupling member 20. The repair device 50 applies the sealant to the surface to be treated 5 by being moved in the narrow space 4c by the automation device 10, which will be described later, while being inserted into the narrow space 4c. A detailed configuration of the repair device 50 will be described later.

Hereinafter, three directions that intersect with each other are referred to as a first direction D1, a second direction D2, and a third direction D3, respectively. In the present embodiment, the first direction D1, the second direction D2, and the third direction D3 are orthogonal to each other. The first direction D1 is orthogonal to a horizontal plane, while the second direction D2 and the third direction D3 are along the horizontal plane. The first direction D1 may be slightly inclined relative to the horizontal plane, and the second direction D2 and the third direction D3 may slightly intersect the horizontal plane. In the following description, the first direction D1 may be referred to as an up-down direction, the second direction D2 may be referred to as a front-back direction, and the third direction D3 may be referred to as a left-right direction.

### Automation Device

The automation device 10 automatically moves the repair device 50 in the second direction D2. The automation device 10 includes a cart 11, a jack 12, and an automation device main body 13.

### Cart

The cart 11 transfers the jack 12 and the automation device main body 13. The cart 11 includes a body 11a, casters 11b, and a handle 11c.

The body 11a is placed slightly above a floor face and extends horizontally. The body 11a is formed in a rectangular shape extending in the second direction D2 (the front-back direction) when viewed in the first direction D1 (the up-down direction).

When viewed in the first direction D1, the casters 11b are provided at four corners of the body 11a. The casters 11b are attached to the underside of the body 11a. Each caster 11b is provided so as to be able to roll on the floor face. The four casters 11b support the body 11a from below.

The handle 11c is provided at one end portion of the body 11a in the second direction D2 (a back side in the front-back direction). The handle 11c extends upward from the body 11a. An operator moves the cart 11 while gripping the handle 11c.

### Jack

The jack 12 is placed on the body 11a of the cart 11. The automation device main body 13 is placed on the jack 12. The jack 12 is provided in an expandable and contractable manner in the first direction D1. Expanding and contracting the jack 12 in the first direction D1 adjusts the position of the automation device main body 13 in the first direction D1.

### Automation Device Main Body

The automation device main body 13 includes a baseplate 14, a movement mechanism 15, and clamp mechanisms 16.

The baseplate 14 is placed on the jack 12.

### Movement Mechanism

The movement mechanism 15 is placed on the baseplate 14. The pipe 6 coupled to the repair device 50 is connected to the movement mechanism 15. The pipe 6 extends in the second direction D2. The movement mechanism 15 grips an end portion of the pipe 6 on a side far from the repair device 50 in the second direction D2 and moves the pipe 6 in the second direction D2. The movement mechanism 15 is, for example, an electric actuator, and includes a base 15a and an actuation unit 15b. The base 15a extends in the second direction D2. The actuation unit 15b is attached to the base 15a. One end portion of the pipe 6 in the second direction D2 is fixed to the actuation unit 15b. The actuation unit 15b moves on the base 15a in the second direction D2. By moving the actuation unit 15b in the second direction D2, the pipe 6 moves in the second direction D2, and the repair device 50 coupled to the pipe 6 also moves in the second direction D2 in conjunction with the pipe 6.

### Clamp Mechanism

The clamp mechanisms 16 are provided at another end portion of the baseplate 14 in the second direction D2 (a front side in the front-back direction). A pair of clamp mechanisms 16 are provided clamping the movement mechanism 15 in the third direction D3 (the left-right direction). The clamp mechanism 16 includes a leg part 16a that stands upward from the baseplate 14, and a clamping part 16b provided at an upper end of the leg part 16a. The leg part 16a supports the clamping part 16b from below. The clamping part 16b clamps the target object 2 from both sides in the first direction D1 (the up-down direction). This prevents positional deviation of the target object 2 in the horizontal direction.

Note that the two clamp mechanisms 16 may be arranged shifted from each other in the second direction D2. With this arrangement, the automation device 10 can be used even when an end portion of the target object 2 closer to the clamp mechanisms 16 is inclined relative to the third direction D3.

### Pipe

The pipe 6 extends from the actuation unit 15b of the movement mechanism 15 to the repair device 50 in the second direction D2. The pipe 6 is coupled to the repair device 50 from the second direction D2. The pipe 6 transmits power to move the repair device 50 placed in the narrow space 4c between the outer panel 3 and the stringer 4 in the second direction D2 (the front-back direction). In the illustrated example, a total of one pair of the pipes 6 are provided, one on each side in the second direction D2 (the front-back direction) relative to the repair device 50, and the automation device 10 is provided only for the pipe 6 on one side in the second direction D2 (the rear side in the front-back direction). Note that the pipe 6 may be provided only on one side of the repair device 50 in the second direction D2 (the rear side in the front-back direction). The automation devices 10 may be provided for the two pipes 6, respectively.

A length L1 of the pipe 6 in the second direction D2 is designed, for example, from 1.5 m to 2.5 m and an outer diameter R1 of the pipe 6 is designed, for example, from 20 mm to 25 mm.

### Coupling Member

The coupling member 20 couples the pipe 6 and a coupling pipe 55b extending from the repair device 50 in the second direction D2.

The coupling member 20 includes a central shaft portion 21, male thread portions 22, and a flange portion 23.

### Central Shaft Portion

The central shaft portion 21 extends in the second direction D2. One end portion of the central shaft portion 21 in the second direction D2 is inserted into one of the pipe 6 and the coupling pipe 55b. Another end portion of the central shaft portion 21 in the second direction D2 is inserted into another of the pipe 6 and the coupling pipe 55b. In the illustrated example, the back end portion of the central shaft portion 21 is inserted into the pipe 6, and the front end portion of the central shaft portion 21 is inserted into the coupling pipe 55b.

### Male Thread Portion

The male thread portions 22 are provided at both end portions of the central shaft portion 21 in the second direction D2. The male thread portions 22 are designed to be able to screwed into inside surfaces of the pipe 6 and the coupling pipe 55b. An outer diameter of the male thread portions 22 is formed to be slightly larger than an inner diameter of the pipe 6 and an inner diameter of the coupling pipe 55b. Thus, the coupling member 20 is firmly coupled to the pipe 6 and the coupling pipe 55b.

### Flange Portion

The flange portion 23 protrudes from an outside surface of the central shaft portion 21 at a central portion in the second direction D2 outward in a radial direction relative to the pipe 6 and the coupling pipe 55b. The flange portion 23 is made of a material (such as resin) that is less hard than the surface to be treated 5. The flange portion 23 prevents the pipe 6 and the coupling pipe 55b from coming into contact with inner surfaces in the narrow space 4c (such as the surface to be treated 5) in the target object 2 including the outer panel 3 and the stringer 4. Note that instead of the flange portion 23, a material having low hardness such as a film or rubber may be wound around the pipe 6 and the coupling pipe 55b. Such means can also prevent the pipe 6 and the coupling pipe 55b from coming into contact with the inner surface in the narrow space 4c and causing damage.

### Configuration of Repair Device

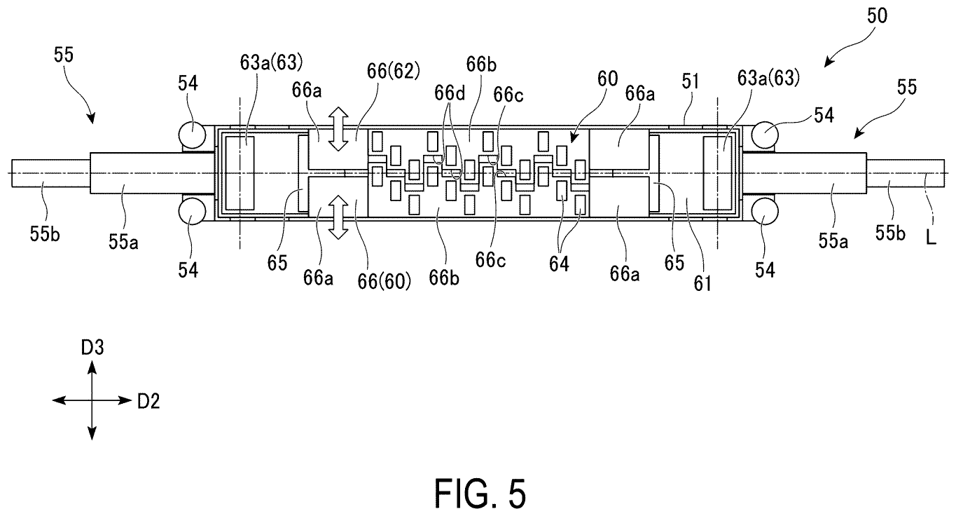

The repair device 50 is placed in the narrow space 4c of the target object 2. The repair device 50 (in the illustrated example, the repair device 50 is inserted into the narrow space 4c from the second direction D2) repairs the surface to be treated 5 in which a defect has occurred. As illustrated in FIGS. 5 to 7, the repair device 50 includes a casing 51, a pan 52, a brush device 60, a jack unit 53, sub-rollers 54, and pipe attachment units 55.

### Casing

The casing 51 extends in the second direction D2. The casing 51 is formed in a box shape having an opening 51a open in the first direction D1. In the present embodiment, the casing 51 is formed in a cubic shape extending in the second direction D2. Tube insertion holes 51b are formed at both end portions of a bottom surface of the casing 51 in the second direction D2. From the tube insertion hole 51b, a tube 53b for supplying air to a bag 53a, which will be described later, is pulled out. Recessed portions 51d recessed toward the bottom surface of the casing 51 are formed in both side edges of the opening 51a of the casing 51 in the third direction D3. The recessed portions 51d extend in the second direction D2. Pull-out holes 51c passing through the casing 51 in the second direction D2 are formed at both end portions of the opening 51a of the casing 51 in the second direction D2.

### Pan

The pan 52 covers a bottom portion of the casing 51 from below. The pan 52 extends in the second direction D2. Both end portions of the pan 52 in the second direction D2 are outside the casing 51 in the second direction D2. The pan 52 is placed on the inner surface in the narrow space 4c (the inner surface of the stringer 4). The tube 53b pulled out from the tube insertion hole 51b is located inside the pan 52. The pan 52 is made of a material such as plastic that can slide on the inner surface in the narrow space 4c without damaging the inner surface in the narrow space 4c. The pan 52 allows the repair device 50 to slide on the inner surface in the narrow space 4c.

Note that the pan 52 does not necessarily have to be provided. In this case, the casing 51 is placed directly on the inner surface in the narrow space 4c.

### Brush Device

The brush device 60 applies sealant to the surface to be treated 5. The brush device 60 is housed in the casing 51 from the first direction D1. The brush device 60 includes an inner casing 61, a base 62, guides 63, brushes 64, and actuators 65.

### Inner Casing

The inner casing 61 is housed in the casing 51 from the opening in the casing 51. The inner casing 61 is formed in a box shape having an opening 61a open on the same side as the casing 51 in the first direction D1. In the present embodiment, the inner casing 61 is formed in a cubic shape extending in the second direction D2. Recessed portions 61b recessed toward the bottom surface of the casing 51 are formed in both side edges of the opening 61a of the inner casing 61 in the third direction D3. The recessed portions 61b extend in the second direction D2. The recessed portion 51d of the casing 51 and the recessed portion 61b of the inner casing 61 are overlapped in the third direction D3.

The inner casing 61 in the present embodiment is formed in a similar shape to the casing 51 when viewed in the first direction D1, and is slidable to the casing 51.

### Base

The base 62 is housed in the inner casing 61. The base 62 includes two divided bodies 66 divided in the third direction D3. The two divided bodies 66 are formed in shapes symmetrical to each other. Each divided body 66 extends in the second direction D2. The divided body 66 includes attachment portions 66a, a brush support portion 66b, and an engaging portion 66c. The attachment portions 66a are provided at both end portions of the divided body 66 in the second direction D2. The attachment portion 66a is attached to the actuator 65, which will be described later. The brush support portion 66b is provided so as to connect the attachment portions 66a in the second direction D2. The brush support portion 66b is located closer to a bottom surface of the inner casing 61 than the attachment portions 66a in the first direction D1, and is located away from the inner casing 61. On a side surface of the divided body 66 facing the other divided body 66, the engaging portion 66c including multiple step portions 66d arranged in the second direction D2 is formed. Three adjacent step portions among the multiple step portions 66d are arranged so as to form one staircase when viewed in the first direction D1. When the three step portions 66d arranged in a staircase pattern are considered as one set, multiple sets (four sets in total in the illustrated example) of the step portions 66d are provided side by side in the second direction D2. By engaging the engaging portions 66c of the pair of divided bodies 66 with each other, positional deviation of the two divided bodies 66 in the second direction D2 is prevented.

### Guide

The guides 63 are housed in the inner casing 61. The guides 63 are positioned at fixed positions relative to the base 62. The guides 63 are attached to the inside of the inner casing 61 at both end portions of the opening 61a in the second direction D2. The guides 63 protrude from the openings in the casing 51 and the inner casing 61 in the first direction D1.

The guides 63 are rollers 63a rotatable about axes extending in the third direction D3.

### Brush

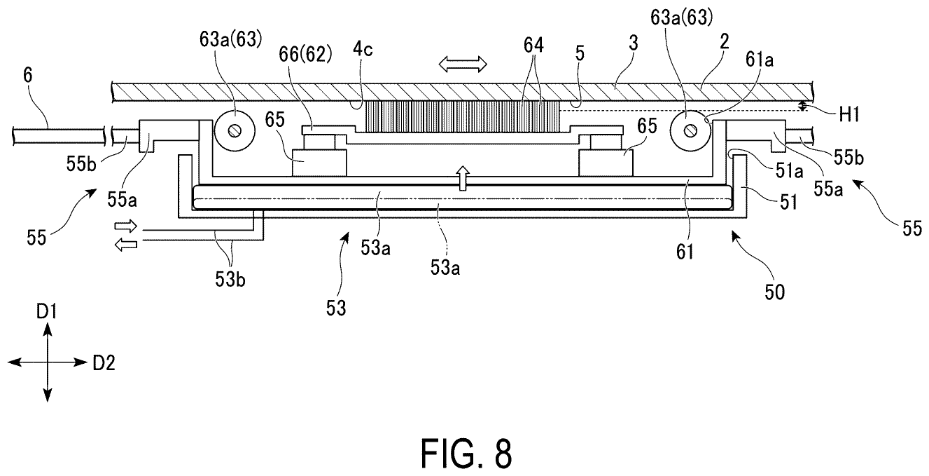

Multiple brushes 64 are attached to the base 62. The brushes 64 apply sealant to the surface to be treated 5 facing in the first direction D1. Each brush 64 protrudes from the openings of the casing 51 and the inner casing 61 in the first direction D1 by a height H1 (see FIG. 8) relative to the guides 63. The height H1 is a small height of about several millimeters. The brushes 64 adjacent to each other in the second direction D2 are shifted from each other in the third direction D3. In the present embodiment, one brush 64 is attached for each step portion 66d, so that the multiple brushes 64 are evenly provided across the divided bodies 66.

### Actuator

The actuators 65 are housed in the inner casing 61. The actuators 65 support the base 62 from below, move the base 62 in the third direction D3 intersecting the first direction D1 and the second direction D2, and can adjust positions of the brushes 64 in the third direction D3. In the present embodiment, the actuators 65 are provided one each at both end portions of the base 62 in the second direction D2. Each actuator 65 is provided so as to connect the two corresponding attachment portions 66a in the third direction D3.

Here, a virtual straight line located between the two divided bodies 66 and extending in the second direction D2 is referred to as a “reference center line L”. The actuators 65 each move the two divided bodies 66 closer to or farther away from each other in the third direction D3 by interlocking the two divided bodies 66 while maintaining equal distances of the two divided bodies 66 from the reference center line L.

### Jack Unit

As illustrated in FIG. 8, the jack unit 53 is positioned between the bottom surface of the casing 51 and the brush device 60. The jack unit 53 can adjust a position of the brush device 60 in the first direction D1 relative to the bottom surface of the casing 51.

The jack unit 53 is the bag 53a configured to adjust the position of the base 62 in the first direction D1 by changing the volume by expanding or contracting using internal air pressure. The bag 53a is a rubber bag that extends over the entire second direction D2 and the third direction D3 and is laid over the entire bottom surface of the casing 51. Other examples of the bag 53a include a rubber balloon. The bag 53a is provided with the tube 53b for supplying or exhausting air, and the tube 53b is pulled out of the casing 51 through the tube insertion hole 51b in the casing 51.

### Sub-Roller

The sub-rollers 54 are provided in pairs on both sides of the casing 51 in the second direction D2, and each pair of the sub-rollers 54 is spaced apart from each other in the third direction D3. In the present embodiment, two are provided at each of both end portions of the pan 52 in the second direction D2. The sub-roller 54 is rotatable about an axis extending in the first direction D1.

### Pipe Attachment Unit

The pipe 6 is attached to the pipe attachment unit 55 via the coupling member 20 described above. The pipe attachment units 55 are provided one each at both end portions of the inner casing 61 in the second direction D2. The pipe attachment unit 55 includes a connection part 55a and the coupling pipe 55b. The connection part 55a is connected to the inner casing 61. The connection part 55a extends from a side surface of the inner casing 61 facing the second direction D2 in the second direction D2. The connection part 55a is pulled out to the outside of the casing 51 in the second direction D2 through the pull-out hole 51c in the casing 51.

### Coupling Pipe

The coupling pipe 55b is arranged in line with the casing 51 in the second direction D2. The coupling pipe 55b extends in the second direction D2 from an end portion of the connection part 55a on a side far from the inner casing 61 in the second direction D2. The coupling pipe 55b is coupled to the pipe 6 via the coupling member 20 described above.

### Controller

The controller 7 is wired to the repair device 50 by a cable (not illustrated). The controller 7 may be wirelessly connected to the repair device 50. For example, the operator can operate the controller 7 to activate the actuators 65 of the repair device 50. The operator can also control supply of air to the bag 53a by operating the controller 7.

### Procedure of Repair Method

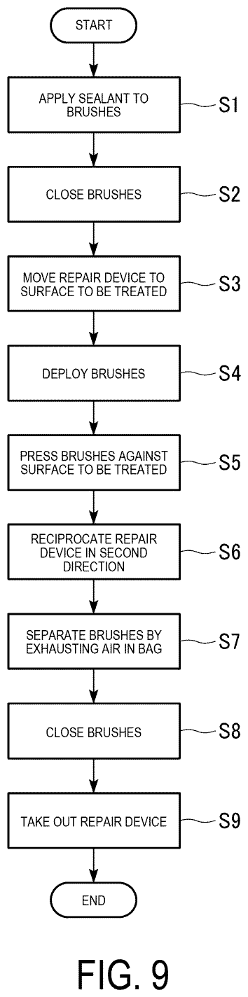

The repair method according to the present embodiment will be described with reference to a flow in FIG. 9. The repair described here is a process (repair process using sealant) in which, for example, when a defect occurs in the narrow space 4c between the outer panel 3 and the stringer 4 included in the target object 2 (aircraft wing), sealant is applied using the brushes 64 to coat the surface to be treated 5.

First, sealant is applied to the brushes (step S1). Then, the actuators 65 are operated to bring the two divided bodies 66 closer to each other in the third direction D3 (left-right direction) to close the brushes 64 (step S2).

Thereafter, with the target object 2 placed such that the outer panel 3 is on the upper side and the stringer 4 is on the lower side, the automation device is activated to insert the repair device 50 into the narrow space 4c from the second direction D2, and move the repair device 50 to the surface to be treated 5, which is an area to be repaired (step S3). Note that in step S3, the operator may grip the pipe 6 and manually move the repair device 50. After step S3, the actuators 65 are operated to move the brushes 64 away from each other in the third direction D3 (left-right direction) to deploy the brushes 64 (step S4).

After step S4, air is supplied into the bag 53a to press the brushes 64 against the surface to be treated 5 in the first direction D1 (step S5). In step S5, when an excessive pressing force is applied to the brushes 64, the guides 63 come into contact with the surface to be treated 5 to prevent the brushes 64 from being pressed excessively.

After step S5, the repair device 50 is moved in the second direction D2 with the brushes 64 being pressed (step S6). In step S6, the movement mechanism 15 of the automation device 10 is activated to reciprocate the repair device 50 in the second direction D2.

After step S6, while moving the repair device 50 in the second direction D2, the air in the bag 53a is exhausted to separate the brushes 64 from the surface to be treated 5 in the first direction D1 (step S7). In order to exhaust the air in the bag 53a, in addition to adjusting a regulator to exhaust the air, for example, the bag 53a is evacuated by connecting the tube 53b for the bag 53a to a vacuum pump.

Thereafter, the actuators 65 are operated to bring the two divided bodies 66 closer to each other in the third direction D3 (left-right direction) to close the brushes 64 (step S8). After step S8, the automation device 10 is activated to pull out the repair device 50 from the narrow space 4c in the second direction D2, and take out the repair device 50 (step S9). Note that in step S9, the operator may grip the pipe 6 and manually pull out the repair device 50.

Through the above steps, the sealant is applied to the surface to be treated 5, and the brush coating is completed.

### Operational Effects

The repair device 50, the repair system 1, and the repair method in the present embodiment can achieve the following operational effects.

In the present embodiment, the repair device 50 includes the casing 51 having a box shape, being open in the first direction D1, and extending in the second direction D2 intersecting the first direction D1, the brush device 60 housed in the casing 51 from the first direction D1, and the jack unit 53 positioned between the bottom surface of the casing 51 and the brush device 60 and configured to adjust a position of the brush device 60 in the first direction D1 relative to the bottom surface of the casing 51. The brush device 60 includes the base 62, the guide 63 attached to the base 62 and protruding from an opening in the casing 51 in the first direction D1, the multiple brushes 64 attached to the base 62, protruding from the opening in the casing 51 in the first direction D1 beyond the guide 63, and configured to apply the sealant to the surface to be treated 5 facing the first direction D1, and the actuator 65 configured to adjust the positions of the multiple brushes 64 in the third direction D3 intersecting the first direction D1 and the second direction D2 by moving the base 62 in the third direction D3.

For example, when repairing a defect occurred in the narrow space 4c between the outer panel 3 and the stringer 4 included in the wing, the repair device 50 is first inserted into the narrow space 4c from the second direction D2. At this time, the repair device 50 is positioned so that the brushes 64 face the surface to be treated 5 in the first direction D1. Subsequently, the jack unit 53 is activated to press the brushes 64 against the surface to be treated 5 from the first direction D1. At this time, when the brushes 64 are excessively pressed against the surface to be treated 5, the guide 63 comes into contact with the surface to be treated 5 and the pressing of the brushes 64 is stopped. Thus, the brushes 64 can be pressed against the surface to be treated 5 with an appropriate pressing force. In this state, by simply moving the entire repair device 50 in the second direction D2, the sealant attached to the brushes 64 can be uniformly applied to the surface to be treated 5.

The positions of the brushes 64 in the third direction D3 can also be adjusted by activating the actuator 65.

In this way, the repair process using sealant can be easily performed even in the narrow space 4c where manual work is difficult.

The guide 63 in the present embodiment is the roller 63a rotatable about the axis extending in the third direction D3.

The guide 63 can rotationally move in the second direction D2 while being in contact with the surface to be treated 5. With the guide 63 in contact with the surface to be treated 5, the repair device 50 can be smoothly moved in the second direction D2. Accordingly, the sealant attached to the brushes 64 can be uniformly applied to the surface to be treated 5.

In the present embodiment, the repair device 50 further includes the sub-rollers 54 provided in pairs on both sides of the casing 51 in the second direction D2, each pair of sub-rollers 54 being spaced apart from each other in the third direction D3, the sub-rollers 54 protruding from the casing 51 in the third direction D3 and being rotatable about the axes extending in the second direction D2.

Thus, when inserting the repair device 50 into the narrow space 4c from the second direction D2, the repair device 50 can be inserted smoothly while preventing positional deviation in the third direction D3. Accordingly, the repair process using sealant can be performed more easily.

The base 62 includes the two divided bodies 66 divided in the third direction D3, and the multiple brushes 64 are evenly provided across the divided bodies 66. The actuator 65 is positioned between the two divided bodies 66 and moves the two divided bodies 66 closer to or farther away from each other in the third direction D3 by interlocking the two divided bodies 66 while maintaining equal distances of the two divided bodies 66 from the reference center line L extending in the second direction D2.

According to the above-described configuration, the brushes 64 can be evenly arranged in the third direction D3, allowing the sealant to be applied with a uniform thickness. Furthermore, by closing the brushes 64 in the third direction D3, adhesion of the sealant to areas other than the area to be repaired can be avoided while moving to the area to be repaired.

In the present embodiment, the jack unit 53 is the bag 53a configured to adjust the position of the base 62 in the first direction D1 by expanding or contracting using the internal air pressure.

Thus, the bag 53a can be positioned in the casing 51 so as to spread in the second direction D2 and the third direction D3. Accordingly, the pressing force in the first direction D1 can be uniformly applied to all the brushes 64.

Further, by adjusting the amount of air supplied to the bag 53a, the position adjustment in the first direction D1 can be performed simply and precisely.

In addition, since the jack unit 53 can have a simple configuration, the repair device 50 can be downsized and manufacturing efficiency of the repair device 50 can be improved.

The repair system 1 includes the repair device 50, the pipe 6 coupled to the repair device 50 from the second direction D2, and the movement mechanism 15 configured to grip the end portion of the pipe 6 on the side far from the repair device 50 in the second direction D2 and move the pipe 6 in the second direction D2.

Thus, positioning of the repair device 50 in the second direction D2 and movement of the repair device 50 in the second direction D2 with the brushes 64 pressed against the surface to be treated 5 can be performed automatically. Accordingly, the entire repair process using sealant can be automated and the repair process using sealant can be performed even more efficiently.

In the present embodiment, the repair device 50 further includes the coupling pipe 55b extending in the second direction D2. The repair system 1 further includes the coupling member 20 configured to couple the pipe 6 and the coupling pipe 55b. The coupling member 20 includes the central shaft portion 21 extending in the second direction D2, with one end portion in the second direction D2 inserted into one of the pipe 6 and the coupling pipe 55b, and another end portion in the second direction D2 inserted into another of the pipe 6 and the coupling pipe 55b, the male thread portions 22 provided at both end portions of the central shaft portion 21 in the second direction D2 and configured to be screwed into the inside surfaces of the pipe 6 and the coupling pipe 55b, and the flange portion 23 protruding radially outward from the outside surface of the central shaft portion 21 at the central portion in the second direction D2, relative to the pipe 6 and the coupling pipe 55b.

The coupling member 20 is firmly fixed to both the pipe 6 and the coupling pipe 55b of the repair device 50 by the male thread portions 22. The flange portion 23 protrudes radially outward relative to the pipe 6 and the coupling pipe 55b. Thus, it is possible to suppress the collisions between the pipe 6 and the coupling pipe 55b and surrounding members (such as the surface to be treated 5). Further, in the present embodiment, since the flange portion 23 is made of a material that is less hard than the surface to be treated 5, damage to the surface to be treated 5 can be avoided even when the flange portion 23 comes into contact with the surface to be treated 5.

In the present embodiment, the length L1 of the pipe 6 in the second direction D2 is designed, for example, from 1.5 m to 2.5 m and the outer diameter R1 of the pipe 6 is designed, for example, from 20 mm to 25 mm.

By designing the cross-sectional dimensions of the pipe 6 (length L1 and outer diameter R1) in this way, the pipe 6 can be flexible enough to follow the curved surface shape of the target object 2 (in the present embodiment, an aircraft wing) and robust enough not to buckle when pressed in the second direction D2. From the viewpoint of achieving both flexibility and robustness, the length L1 of the pipe 6 is most preferably designed to be, for example, 2.0 m, and the outer diameter R1 of the pipe 6 is most preferably designed to be, for example, 22 mm. When the pipe 6 and the repair device 50 are coupled, it is desirable that a length from the pipe 6 to the repair device 50 in the second direction D2 be, for example, 30 m or less. In this way, even when the pipe 6 and the repair device 50 are coupled, the pipe 6 is less likely to buckle when the repair device 50 is pushed or pulled in the second direction D2 by the pipe 6.

The repair method in the present embodiment includes pressing the multiple brushes 64 against the surface to be treated 5 in the first direction D1 by supplying air into the bag 53a, moving the repair device 50 in the second direction D2 with the multiple brushes 64 pressed against the surface to be treated 5, and separating the multiple brushes 64 from the surface to be treated in the first direction D1 by exhausting the air in the bag 53a while moving the repair device 50 in the second direction D2.

After the sealant is applied, the air in the bag 53a is exhausted to gradually separate the brushes 64 from the surface to be treated 5. Thus, formation of brush marks on the surface to be treated 5 can be avoided. Accordingly, accuracy of the repair using sealant can be further improved.

### Other Embodiments

An embodiment according to the present disclosure has been described in detail with reference to the drawings. However, the specific configuration of the present disclosure is not limited to this embodiment. Design change without departing from the main gist of the present disclosure or the like is also included.

Note that in the above-described embodiment, a case has been described in which the automation device 10 moves the repair device 50 in the second direction D2, but movement of the repair device 50 is not limited to the use of the automation device 10. For example, two or more operators may each grip the two pipes 6 extending from both sides of the repair device 50 in the second direction D2, respectively, and manually move the repair device 50 in the second direction D2. In the case of manual operation, by marking the pipe 6 or the mechanism that holds the pipe 6 (e.g., the base 15a of the movement mechanism 15) with scales or marks, the inspection device 50 can be reciprocated within an accurate operation range.

Alternatively, instead of the pipes 6, two wires may be provided one on each side of the repair device 50 in the second direction D2 (the front-back direction), and the repair device 50 may be moved in the second direction D2 by pulling these two wires in the second direction D2.

In the above-described embodiment, a case has been described in which the jack unit 53 is the bag 53a that can adjust the position of the base 62 in the first direction D1 by changing the volume by adjusting the amount of air in the bag 53a. However, the jack unit 53 is not limited to the bag 53a. For example, the jack unit 53 may be an air cylinder, an oil cylinder, an electric actuator, or the like that can be extended and retracted in the first direction D1.

In the above-described embodiment, the guide 63 is the roller 63a rotatable about the axis extending in the third direction D3, but the guide 63 is not limited to the roller 63a. For example, the guide 63 may be a block made of a material slidable on the surface to be treated 5.

### Supplementary Notes

The repair device 50, the repair system 1, and the repair method according to the embodiments are understood as follows, for example.
(1) A repair device 50 according to a first aspect includes the casing 51 having a box shape, being open in the first direction D1, and extending in the second direction D2 intersecting the first direction D1, the brush device 60 housed in the casing 51 from the first direction D1, and the jack unit 53 positioned between the bottom surface of the casing 51 and the brush device 60 and configured to adjust the position of the brush device 60 in the first direction D1 relative to the bottom surface of the casing 51, in which the brush device 60 includes the base 62, the guide 63 positioned at the fixed position relative to the base 62 and protruding from an opening in the casing 51 in the first direction D1, the multiple brushes 64 attached to the base 62, protruding from the opening in the casing 51 in the first direction D1 beyond the guide 63, and configured to apply the sealant to the surface to be treated 5 facing the first direction D1, and the actuator 65 configured to adjust the positions of the multiple brushes 64 in the third direction D3 intersecting the first direction D1 and the second direction D2 by moving the base 62 in the third direction D3.

For example, when repairing a defect occurred in the narrow space 4c between the outer panel 3 and the stringer 4 included in the wing, the repair device 50 is first inserted into the narrow space 4c from the second direction D2. At this time, the repair device 50 is positioned so that the brushes 64 face the surface to be treated 5 in the first direction D1. Subsequently, the jack unit 53 is activated to press the brushes 64 against the surface to be treated 5 from the first direction D1. At this time, when the brushes 64 are excessively pressed against the surface to be treated 5, the guide 63 comes into contact with the surface to be treated 5 and the pressing of the brushes 64 is stopped. Thus, the brushes 64 can be pressed against the surface to be treated 5 with an appropriate pressing force.

The positions of the brushes 64 in the third direction D3 can also be adjusted by activating the actuator 65.
(2) In a repair device 50 of a second aspect, in the repair device 50 of (1), the guide 63 may be the roller 63a rotatable about the axis extending in the third direction D3.

The guide 63 can rotationally move in the second direction D2 while being in contact with the surface to be treated 5. With the guide 63 in contact with the surface to be treated 5, the repair device 50 can be smoothly moved in the second direction D2.
(3) A repair device 50 of a third aspect, in the repair device 50 of (1) or (2), may further include the sub-rollers 54 provided in pairs on both sides of the casing 51 in the second direction D2, each pair of sub-rollers 54 being spaced apart from each other in the third direction D3, the sub-rollers 54 protruding from the casing 51 in the third direction D3 and being rotatable about the axes extending in the second direction D2.

Thus, when inserting the repair device 50 into the narrow space 4c from the second direction D2, the repair device 50 can be inserted smoothly while preventing positional deviation in the third direction D3.
(4) In a repair device 50 of a fourth aspect, in the repair device 50 of any one of (1) to (3), the base 62 includes the two divided bodies 66 divided in the third direction D3, the multiple brushes 64 are evenly provided across the divided bodies 66, and the actuator 65 is positioned between the two divided bodies 66 and moves the two divided bodies 66 closer to or farther away from each other in the third direction D3 by interlocking the two divided bodies 66 while maintaining equal distances of the two divided bodies 66 from the reference center line L extending in the second direction D2.

According to the above-described configuration, the brushes 64 can be evenly arranged in the third direction D3, allowing the sealant to be applied with a uniform thickness. Furthermore, by closing the brushes 64 in the third direction D3, adhesion of the sealant to areas other than the area to be repaired can be avoided while moving to the area to be repaired.
(5) In a repair device 50 of a fifth aspect, in the repair device 50 of any one of (1) to (4), the jack unit 53 may be the bag 53a configured to adjust the position of the base 62 in the first direction D1 by expanding or contracting using the internal air pressure.

Thus, the bag 53a can be positioned in the casing 51 so as to spread in the second direction D2 and the third direction D3. Accordingly, the pressing force in the first direction D1 can be uniformly applied to all the brushes 64.
(6) A repair system 1 of a sixth aspect includes the repair device 50 of any one of (1) to (5), the pipe 6 coupled to the repair device 50 from the second direction D2, and the movement mechanism 15 configured to grip the end portion of the pipe 6 on the side far from the repair device 50 in the second direction D2 and move the pipe 6 in the second direction D2.

Thus, positioning of the repair device 50 in the second direction D2 and movement of the repair device 50 in the second direction D2 with the brushes 64 pressed against the surface to be treated 5 can be performed automatically.
(7) In a repair system 1 of a seventh aspect, in the repair system 1 of (6), the repair device 50 may further include the coupling pipe 55b extending in the second direction D2, the repair system 1 of the seventh aspect may further include the coupling member 20 configured to couple the pipe 6 and the coupling pipe 55b, and the coupling member 20 may include the central shaft portion 21 extending in the second direction D2, with one end portion in the second direction D2 inserted into one of the pipe 6 and the coupling pipe 55b, and another end portion in the second direction D2 inserted into another of the pipe 6 and the coupling pipe 55b, the male thread portions 22 provided at both end portions of the central shaft portion 21 in the second direction D2 and configured to be screwed into the inside surfaces of the pipe 6 and the coupling pipe 55b, and the flange portion 23 protruding radially outward from the outside surface of the central shaft portion 21 at the central portion in the second direction D2, relative to the pipe 6 and the coupling pipe 55b.

The coupling member 20 is firmly fixed to both the pipe 6 and the coupling pipe 55b of the repair device 50 by the male thread portions 22. The flange portion 23 protrudes radially outward relative to the pipe 6 and the coupling pipe 55b. Thus, it is possible to suppress the collisions between the pipe 6 and the coupling pipe 55b and the surface to be treated 5 or the like located nearby.
(8) A repair method of an eighth aspect is a repair method using the repair device 50 of any one of (1) to (5), in which the jack unit 53 is the bag 53a configured to adjust the position of the base 62 in the first direction D1 by changing the volume by adjusting the amount of air in the bag 53a, the repair method includes pressing the multiple brushes 64 against the surface to be treated 5 in the first direction D1 by supplying air into the bag 53a, moving the repair device 50 in the second direction D2 with the multiple brushes 64 pressed against the surface to be treated 5, and separating the multiple brushes 64 from the surface to be treated 5 in the first direction D1 by exhausting the air in the bag 53a while moving the repair device 50 in the second direction D2.

After the sealant is applied, the air in the bag 53a is exhausted to gradually separate the brushes 64 from the surface to be treated 5. Thus, formation of brush marks on the surface to be treated 5 can be avoided.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A repair device comprising:
a casing having a box shape, being open in a first direction, and extending in a second direction intersecting the first direction;
a brush device housed in the casing from the first direction; and
a jack unit positioned between a bottom surface of the casing and the brush device and configured to adjust a position of the brush device in the first direction relative to the bottom surface of the casing, wherein
the brush device includes
a base,
a guide positioned at a fixed position relative to the base and protruding from an opening in the casing in the first direction,
multiple brushes attached to the base, protruding from the opening in the casing in the first direction beyond the guide, and configured to apply sealant to a surface to be treated facing the first direction, and
an actuator configured to adjust positions of the multiple brushes in a third direction intersecting the first direction and the second direction by moving the base in the third direction.

2. The repair device according to claim 1, wherein the guide is a roller rotatable about an axis extending in the third direction.

3. The repair device according to claim 1, further comprising sub-rollers provided in pairs on both sides of the casing in the second direction, each pair of sub-rollers being spaced apart from each other in the third direction, the sub-rollers protruding from the casing in the third direction and being rotatable about axes extending in the second direction.

4. The repair device according to claim 1, wherein
the base includes two divided bodies divided in the third direction,
the multiple brushes are evenly provided across the two divided bodies, and
the actuator is positioned between the two divided bodies and moves the two divided bodies closer to or farther away from each other in the third direction by interlocking the two divided bodies while maintaining equal distances of the two divided bodies from a reference center line extending in the second direction.

5. The repair device according to claim 1, wherein the jack unit is a bag configured to adjust a position of the base in the first direction by expanding or contracting using internal air pressure.

6. A repair system comprising:
the repair device according to claim 1;
a pipe coupled to the repair device from the second direction; and
a movement mechanism configured to grip an end portion of the pipe on a side far from the repair device in the second direction and move the pipe in the second direction.

7. The repair system according to claim 6, wherein
the repair device further includes a coupling pipe extending in the second direction,
the repair system further comprising a coupling member configured to couple the pipe and the coupling pipe, and
the coupling member includes
a central shaft portion extending in the second direction, with one end portion in the second direction inserted into one of the pipe and the coupling pipe, and another end portion in the second direction inserted into another of the pipe and the coupling pipe,
male thread portions provided at both end portions of the central shaft portion in the second direction and configured to be screwed into inside surfaces of the pipe and the coupling pipe, and
a flange portion protruding radially outward from an outside surface of the central shaft portion at a central portion in the second direction, relative to the pipe and the coupling pipe.

8. A repair method using the repair device according to claim 1,
the jack unit being a bag configured to adjust a position of the base in the first direction by expanding or contracting using internal air pressure, the repair method comprising:
pressing the multiple brushes against the surface to be treated facing the first direction in the first direction by supplying air into the bag;
moving the repair device in the second direction with the multiple brushes pressed against the surface to be treated; and
separating the multiple brushes from the surface to be treated in the first direction by exhausting the air in the bag while moving the repair device in the second direction.
